(19) United States
(12) Patent Application Publication
(10) Pub. No.: US 2016/0278376 A1
(43) Pub. Date: Sep. 29, 2016

(54) USE OF ALDEHYDES TO ENHANCE DISEASE RESISTANCE OF PLANTS TO LIBERIBACTERS

(71) Applicants: UNIVERSITY OF FLORIDA RESEARCH FOUNDATION, INC., Gainesville,, FL (US); INTEGRATED PLANT GENETICS, INC., Gainesville, FL (US)

(72) Inventors: Dean W. GABRIEL, Gainesville, FL (US); Shujian ZHANG, Gainesville, FL (US)

(21) Appl. No.: 15/035,113

(22) PCT Filed: Nov. 10, 2014
(86) PCT No.: PCT/US14/64835

§ 371 Date: May 6, 2016

Related U.S. Application Data
(60) Provisional application No. 61/902,087, filed on Nov. 8, 2013.

(51) Int. Cl. A01N 35/02; A01N 25/02

(52) U.S. Cl. CPC A01N 35/02; A01N 25/02

(57) ABSTRACT

Methods and compositions based upon using phenolic aromatic aldehydes (ex: cinnamaldehyde, benzaldehyde) are provided, which find use as agents for treating, preventing, or curing systemic bacterial infections of living plants, in particular against Gram negative bacteria and more particularly species of Liberibacter, including Ca. Liberibacter asiaticus. The agent compositions described are used synergistically with other antimicrobial compounds, such as those that plants manufacture or release as a result of biotic or abiotic stresses, including the application of the aldehydes, proteins, whether produced by recombinant methods or not, or by essential oils such as carvacrol or allicin. Methods of applying the compositions for agriculture use are disclosed.

### CROSS-REFERENCE TO RELATED APPLICATIONS

This application claims the benefit of U.S. provisional application No. 61/902,087 filed on Nov. 8, 2013, which is hereby incorporated by reference in its entirety.

### FIELD OF THE INVENTION

The present disclosure relates to methods and compositions for treating systemic infections of crop species.

### BACKGROUND OF THE INVENTION

Huanglongbing (HLB), commonly known as citrus “greening” disease, is one of the top three most damaging diseases of citrus in Africa, America and Asia. HLB is naturally transmitted by psyllids, and experimentally by grafting or dodder (Cuscuta spp.). The disease was shown to be graft-transmissible in 1956 (Lin, 1956) and therefore it was thought to be caused by a putative virus. However, in 1970, sieve tube restricted bacteria were discovered in affected trees. First thought to be mycoplasma-like (Laflèche and Bové, 1970), they were soon recognized as walled bacteria (Saglio et al., 1971; Bové and Saglio, 1974) of the Gram negative type (Gamier et al., 1984) and finally shown to be species of alpha proteobacteria (Jagoueix, et al. 1994). Two species were recognized: Candidatus Liberibacter asiaticus (Las) for the disease in Asia and Ca. L. africanus (Laf) for the disease in Africa.

In 2004, when HLB was seen for the first time in the Americas and more precisely in São Paulo State, Brazil, two liberibacter species were identified: (i) a new species, Ca. L. americanus (Lam), infecting most of the affected trees, and (ii) the known Asian liberibacter, Las, present in a minority of trees (Teixeira et al., 2005). All three citrus liberibacters are uncultured and phloem-limited. That is, these bacteria live in plants exclusively within living plant phloem cells. Las is the most widely distributed by far. Today, HLB has been identified in states ranging from Florida, Louisiana, and California.

With no effective treatment options available in the market, there is a growing demand for new technologies to combat its spread.

### SUMMARY OF THE INVENTION

The disclosure teaches compositions useful for protecting or treating plants against intracellular bacterial attack and infection and particularly for treatment of existing plants infected with systemic Liberibacter species, comprising at least one aromatic aldehyde species, in concentrations sufficient for eliciting plant defense responses. This disclosure also teaches use of at least one polar solvent that is useful for delivery and penetration of the aldehyde into plant cells.

In some embodiments, the present invention teaches compositions and methods useful for curing and protecting crops, including tree crops, against intracellular bacterial disease, including disease caused by bacterial species of the genus Liberibacter, comprising at least one aromatic aldehyde species.

In some embodiments, the application or injection of the composition of the present invention results in a reduction in the number of bacteria. In other embodiments, the application or injection of the composition results in a reduction in the number of bacteria, the incidence of disease, or the incidence of disease symptoms. Thus for example in some embodiments, application of compositions of the present invention improves the growth or fruit yield of Liberibacter infected plants.

In some embodiments, the curing and protecting of plants, is measured against an infected control plant that has not been treated with the compositions. In other embodiments, the reduction in bacteria, incidence of disease, or incidence of disease symptoms are measured against an infected control crop that has not been treated with the compositions.

In some embodiments, the application or injection of the composition results in a partial clearance of the bacteria from the plant, as compared to an untreated infected plant. In further embodiments, the partial clearance may be 5%, 10%, 15%, 20%, 25%, 30%, 35%, 40%, 45%, 50%, 60%, 65%, 70%, 75%, 80%, 85%, 90%, 95%, 96%, 97%, 98%, or 99%.

In other embodiments, the application or injection of the composition results in the plant being cured.

In some embodiments, the aromatic aldehyde species of the present invention are selected from the group consisting of cinnamaldehyde, coniferyl aldehyde, carvacrol, and geriniol. In a particular embodiment, the composition comprises cinnamaldehyde as the aromatic aldehyde.

In some embodiments, the composition comprises a short chain (C₁-C₆) alcohol or dimethyl sulfoxide (DMSO) solvents for the application and cell penetrating delivery of the aldehyde formulation.

In some embodiments taught herein, the polar solvent is at least one selected from the group consisting of methanol, ethanol, propanol, butanol, pentanol, hexanol and DMSO. In some embodiments, the polar solvent is ethanol. In other embodiments, the polar solvent is DMSO.

In some embodiments of the present invention, the method for curing and/or controlling intracellular bacteria in plants comprises injecting a plant with a composition comprising at least one aromatic aldehyde.

In some embodiments, the method of injection of a plant is by pressurized syringe.

In another embodiment, the method of injection of a plant is by drip bag.

In some embodiments of the present invention, the method for curing and/or controlling intracellular bacteria in plants comprises foliar spray of a composition comprising at least one aromatic aldehyde species.

In some embodiments, the intracellular bacteria infecting the plant are limited to the phloem.

In some embodiments, the intracellular bacteria infecting the plant are Liberibacters.

In some embodiments, the composition utilized in the taught methods comprises cinnamaldehyde as an aromatic aldehyde.

In another particular embodiment, the composition utilized in the taught methods comprises ethanol as a polar solvent for the aromatic aldehyde.

Further taught herein are compositions comprising (a) at least one aromatic aldehyde; and (b) at least one polar solvent, wherein said at least one aromatic aldehyde comprises cinnamaldehyde and at least one polar solvent comprises DMSO.

In some embodiments, the methods taught herein include the step of injecting or spraying one or more parts or tissues of a diseased plant, or a plant susceptible to attack by pathogens, with cinnamaldehyde, and a penetrating solvent in an amount sufficient to control growth of target pathogenic organisms.

In some embodiments, the compositions taught herein are effective as antibacterial curing agents against infections of Liberibacter, including, but not limited to Ca. L. asiaticus, causing Huanglongbing (HLB) disease.

In some embodiments, the composition relates to an injectable solution of aromatic aldehyde in greater than 5% ethyl alcohol.

In some embodiments, the composition relates to an injectable solution of aromatic aldehyde in up to about 100% DMSO.

In other embodiments, the taught composition is a solution comprising about 1.5% cinnamaldehyde in about 50% DMSO.

In other embodiments, the taught composition is a solution comprising about 1.5% cinnamaldehyde in about 100% DMSO.

The compositions of cinnamaldehyde and plant cell penetrating solvent such as DMSO or ethanol according to the present invention provide enhanced permeation of cinnamaldehyde, and combined with the natural defense systems of plants, or combined with a synergistic additional element, either a chemical or the genetically enhanced defense systems of plants, provides a prevention, inhibition, and/or cure for diseases caused by Liberibacters and likely other bacteria that live within living plant cells.

In some embodiments, the present invention teaches methods for treating a plant infected with a Liberibacter, said method comprising: contacting or injecting one or more parts of said plant with a composition comprising (i) at least one aromatic aldehyde; and (ii) at least one penetrating polar solvent; wherein said treated plant has reduced levels of Liberibacter.

In some embodiments, the aromatic aldehyde used in the methods of the present invention comprises cinnamaldehyde.

In some embodiments, the at least one polar solvent used in the methods of the present invention comprises DMSO.

In some embodiments, the methods of the present invention use a composition wherein the at least one aromatic aldehyde comprises cinnamaldehyde and the at least one polar solvent comprises DMSO.

In some embodiments the composition of the present invention is contacted with said plant by foliar spray.

In other embodiments, the composition of the present invention is injected into the plant.

In some embodiments, the methods of the present invention treat Liberibacter infections which are causing or caused citrus greening disease in the plant.

In some embodiments the Liberibacters of the present invention are selected from the group consisting of Ca. L. asiaticus, Ca. L. africanus and Ca. L. americanus.

In some embodiments, the methods of the present invention cure the plant from the Liberibacter infection.

In some embodiments, the treated plant of the present invention is a citrus tree or seedling.

Thus, In some embodiments, the present invention teaches a method for treating a plant infected with a Liberibacter, said method comprising: a) contacting or injecting one or more parts of said plant with a composition comprising (i) at least one aromatic aldehyde; and (ii) at least one penetrating polar solvent; wherein said at least one aromatic aldehyde comprises cinnamaldehyde and said at least one polar solvent comprises DMSO, and wherein the Liberibacter is selected from the group consisting of Ca. L. asiaticus, Ca. L. africanus and Ca. L. americanus, and wherein said treated plant has reduced levels of Liberibacter.

In some embodiments, the present invention teaches a composition for reducing the levels of Liberibacter in an infected plant, said composition comprising: (a) at least one aromatic aldehyde; and (b) at least one penetrating polar solvent, wherein the at least one aromatic aldehyde comprises cinnamaldehyde and the at least one polar penetrating solvent comprises DMSO.

In some embodiments the composition of the present invention is applied as a foliar spray.

In some embodiments the foliar spray is applied to the point of run-off.

In other embodiments, the composition of the present invention is injected into the plant.

In some embodiments, the composition of the present invention cures Liberibacter infected plants from their Liberibacter infection.

In some embodiments the composition of the present invention reduces the levels Liberibacter infection which causes citrus greening disease.

In some embodiments the present invention teaches the use of qPCR to detect Liberibacter infection.

### BRIEF DESCRIPTION OF THE DRAWINGS

FIG. 1. Effect of Carvacrol, Cinnamaldehyde and Geraniol against E. coli cells. Twenty microliter drops of three chemicals (at 100% strength) were placed on paper assay discs on top of E. coli lawn. Control disc included a solution of 70% ethanol without any added essential oil. Dotted line circles indicate zone of inhibition. Photo taken at 24 hrs after plating.

FIG. 2. Effect of Carvacrol, Cinnamaldehyde and Geraniol against Liberibacter crescens cells. Twenty microliter drops of three chemicals, each diluted to a concentration of 2mg/ml were placed on paper assay discs on top of L. crescens lawn. Control disc included a solution of 70% ethanol without any added essential oil. Dotted line circles indicate zone of inhibition. Photo taken at 5 days after plating.

FIG. 3. Normalized percent infection rate with Las of Hamlin citrus trees grafted onto Swingle citrumello rootstock, as measured over a period of approximately seven months. Results are presented as % Las infection (total number of positive leaf samples (assessed by qPCR as described above) divided by the total number of leaf samples taken per treatment on a given sampling date). Samples were taken monthly over a period of 6-7 months. Each bar in FIG. 3 represents average % Las infection for each treatment of 10 trees, and annotated by month sampled. The “0 month” samples are pooled averages of all trees sampled in each treatment before any treatments. Data are presented are normalized such that pre-treatment infections are 100%. Non-overlapping Standard Errors are significant at P<0.05. The control group comprises 5 trees that were sprayed with 50% DMSO and 5 trees that were injected with 50% DMSO. The experimental treatments are as follows, Treatment 1: trunk injection with 40 ml of 1.5% (w/v) cinnamaldehyde and 50% DMSO, followed by reapplication at month 4; Treatment 2: foliar spray 800 ml of 1.5% cinnamaldehyde in 50% DMSO, followed by reapplication at month 4.

FIG. 4. Hamlin orange fruit yield, measured by pounds per tree, represented as total fruit weight per tree measured. The control and experimental groups are as described above in FIG. 3.

### DETAILED DESCRIPTION OF THE INVENTION

Citrus Greening

Huanglongbing (HLB), commonly known as citrus “greening” disease, is caused by a partially systemic bacterial infection of trees and other crop species, leading to leaf discoloration and reduced fruit production. In Florida, the spread of the invasive HLB disease presents a major threat to the citrus industry, whose loses due to this infection have reached millions of dollars per year. Since the insect vector has reached Texas and California, it is only a matter of time until the disease breaks out in those states as well.

HLB has been associated with infections from three liberibacter species: Candidatus Liberibacter asiaticus (Las) for the disease in Asia, Ca. L. africanus (Laf) for the disease in Africa, and Ca. L. americanus (Lam), for the disease in the Americas.

All three citrus liberibacters are uncultured and phloem-limited. That is, these bacteria live in plants entirely within living plant phloem cells. Las is the most widely distributed by far. In the whole of Asia, from the Indian subcontinent to Papua-New Guinea, HLB is exclusively caused by Las and transmitted by the Asian citrus psyllid, Diaphorina citri. Prior to 2004, Las was reported present only in Asia; it is now reported present in North, Central and South America. In Africa and Madagascar, HLB is caused by Laf and transmitted by the African citrus psyllid, Trioza erytreae. The “African” disease occurs in cool areas, often above 600 m altitude, with temperatures below 30° C. Both Laf and T. erytreae are native to Africa (Hollis, 1984; Beattie et al., 2008; Bové, 2013) and both are heat sensitive (Moran and Blowers, 1967; Catling, 1969; Schwarz and Green, 1972; Bové et al., 1974). In Brazil, both Las and Lam are transmitted by D. citri, the Asian citrus psyllid. Lam is significantly less heat tolerant than Las (Lopes et al., 2009b).

Beside the three citrus Liberibacters associated with HLB, three non-citrus Liberibacter species have been described. Ca. L. solanacearum (Lso), has been identified as the causal agent of serious diseases of potato (“Zebra chip”), tomato (“psyllid yellows”) and other solanaceous crops in the USA, Mexico, Guatemala, Honduras, and New Zealand (Hansen et al., 2008; Abad et al., 2009; Liefting et al., 2009; Secor et al., 2009). In solanaceous crops, Lso is vectored by the tomato/potato psyllid Bactericera cockerelli. More recently, a different haplotype of Lso was found infecting carrots in Sweden, Norway, Finland, Spain and the Canary Islands (Alfaro-Fernandez et al., 2012a, 2012b Munyaneza et al., 2012a, 2012b; Nelson et al., 2011). The carrot haplotype of Lso is spread by the carrot psyllid Trioza apicalis, which does not feed on Solanaceae. A fifth species of Liberibacter, Ca. L. europaeus (Leu) was recently found in the psyllid Cacopsylla pyri, the vector of pear decline phytoplasma. With C. pyri as the vector, Leu was transmitted to pear trees in which the liberibacter reached high titers but did not induce symptoms, thus behaving as an endophyte rather than a pathogen (Raddadi et al., 2011). Finally, a sixth species of Liberibacter, Liberibacter crescens (Lcr), was recently characterized after isolation from diseased mountain papaya (Babaco). Except for Lcr, which is not known to be pathogenic, all other described Liberibacters are pathogenic and must be injected into living plant cells by specific insects. Furthermore, the pathogenic Liberibacters can only live within specific insect and plant cells; as obligate parasites, they do not have a free living state.

To date, Lcr is the only Liberibacter to be grown in axenic culture (Leonard et al., 2012), and thus can serve as a proxy for in vitro testing of antimicrobial chemicals. Lcr has not been reported to date to have been successfully reinoculated and grown in any plant. In plants, Liberibacters live entirely within living phloem cells. They become partially systemic in plants, moving from the site of injection by phloem to the roots and to newly forming leaf and stem tissues. Exposure of these bacteria to chemicals that may control them requires that the chemicals first penetrate multiple plant or insect cell layers and then to move in a systemic or semi-systemic manner.

Disease Adaptations may Help Citrus Greening Bacteria Avoid Triggering the Plant Innate Immune System

Despite the fact that Las and Lam have an intact outer membrane and presumably Lso does as well (Wulffe et al, 2014), most of the genes required for lipopolysaccharide (LPS) biosynthesis that are found in Las and Lso are missing from Lam, including lpxA, lpxB, and lpxC, which are involved in the first steps of the biosynthesis of lipid-A. Lack of LPS in Gram-negative species is very rare but the barrier function served by the LPS may not be needed by pathogenic Liberibacters. If the LPS is not needed as a barrier function in one Liberibacter then it may not function well as a barrier in the others, which may provide opportunities for unusual chemical control measures that would not likely work against bacteria with typical LPS barriers. Broad-spectrum antibiotics injected into trees have resulted in some degree of success, including penicillin G (Aubert and Bove, 1980; Zhang, Duan et al., 2010; Zhang, Powell et al., 2011).

Indeed, the barrier function normally provided by the LPS may be at least partially compensated by production of other classes of lipids in the outer membrane. For example, Treponema denticola was shown to be missing LPS but possessing instead a lipoteichoic acid-like membrane lipid, core structure and repeating units that functioned as a substitute permeation barrier (Schultz et al., 1998). Similarly, Sphingomonas paucimobilis (Kawahara et al., 1991) and S. capsulate (Kawahara et al., 2000) are devoid of LPS, but have as substitutes glycosphingolipids containing (S)-2-hydroxymyristic acid. In addition, Sorangium cellulosum produces sphingolipids as the major lipid class in the outer membrane, together with ornithine-containing lipids and ether lipids (Keck et al., 2011).

The loss of the Lam LPS indicates a distinct selection advantage served by losing the LPS, which is a major elicitor of plant innate immunity, or natural defense response. The LPS is one of several classic “pathogen-associated molecular patterns” or PAMPs, which are generally conserved molecules of microbial origin that are recognized by specific plant receptors, often in a synergistic manner, to trigger both early and late defense responses, including the oxidative burst, salicylic acid accumulation and callose deposition (Zipfel & Robatzek, 2010). Importantly, a defective LPS can still be capable of inducing PAMP triggered immunity (Deng et al., 2010).

Plant pathogenic microbes must either avoid PAMP recognition or actively suppress the plant defense responses that result from such recognition (Hann et al., 2010). Clearly, defects in the LPS barrier function would render Lam much more sensitive to innate plant immune responses than to most plant pathogenic microbes, but loss of all LPS components capable of PAMP activity should result in a reduced response in the first place.

In addition to missing nearly all LPS encoding genes, Lam is also missing a key outer membrane protein, OmpA, which helps stabilize the outer membranes of Gram negative bacteria, providing its structural shape, and anchoring it to the peptidoglycan layer (Smith et al. 2007). OmpA is the most abundant outer membrane protein in Enterobacteria (Bosshart et al. 2012); it is present at 100,000 copies cell-1 in E. coli (Koebnik et al. 2000). In E. coli, OmpA is believed to be a weak porin, involved in diffusion of nonspecific small solutes across the outer membrane (Sugawara and Nikaido 1992). OmpA is a major PAMP (Jeannin et al., 2002).

The phosphatidylcholine (PC) synthase pathway (de Rudder et al., 1999), which is unique to a small number (10-15%) of bacteria, including Rhizobium and Agrobacterium (Geiger et al., 2013) is found in all sequenced Liberibacters (Lam_551; CLIBASIA_03680; CKC_04930; B488_05590), and could enable PC biosynthesis from the abundant choline present in either plant or insect host. In those bacteria synthesizing PC, PC strongly affects the physicochemical properties of the bacterial membranes (Geiger et al., 2013). Agrobacterium tumefaciens mutants lacking PC are markedly impaired in virulence and are hypersensitive to detergent (Wessel et al., 2006). Finally, Thermus thermophilus has no LPS but polar glycolipids and a phosphoglycolipid were detected in the outer membrane (Leone et al., 2006).

Although a nearly complete set of flagellar biosynthetic genes were reported in Las, some of the flagella biosynthetic genes were reported as pseudogenes (Duan et al., 2009). However, no Las or Lam flagella have been reported observed in any publications, despite numerous electron micrographs of these bacteria infecting plants and psyllids (for example, Bove, 2006). The lack of flagella indicates inability to produce or activate flagellin expression, resulting in loss of this PAMP activity. Both Las and Lam have clearly evolved a strategy of PAMP avoidance, due to an intracellular lifestyle that depends upon avoidance of activation of host defense and cell death responses. Any chemicals that trigger plant defense responses, such as salicyclic acid (SA) (Pieterse et al., 1996) or neonicotinoid pesticides (Ford et al., 2010) would place the Liberibacter outer membrane barrier function as a likely very sensitive last line of defense against these plant defenses.

Liberibacter spread is controlled primarily and poorly through control of the psyllid vector, primarily through the use of neonicotinoid pesticides. There are no known effective control measures known against the systemic Liberibacter pathogens in plants, and no known way to cure an infected plant. Since the HLB disease causes such severe citrus fruit losses and eventually death of the citrus tree, and since citrus trees in groves can last 15-25 years, these trees represent a considerable investment. A cure for the disease is urgently needed.

Treating Citrus Greening (Huanglongbing or HLB).

The present invention is based in part on the discovery that aromatic aldehydes, when combined with a solvent penetrant such as DMSO, can provide a beneficial phytotoxic composition capable of treating HLB caused by liberibacter infections. While the inventors do not wish to be bound by any one theory of function, they hypothesize that penetration of low levels of aldehydes through the plant cells by the action of DMSO causes failure of the Liberibacter outer membrane barrier function. Thus the inventors hypothesize that when combined with the non-lethal phytotoxic stress responses caused by the application of the compositions of the present invention, a beneficial systemic clearing effect is caused in the plant.

Cinnamaldehyde as a Disinfectant

Cinnamaldehyde is an organic aromatic aldehyde compound that is best known for giving cinnamon its flavor and odor. The pale yellow viscous liquid occurs naturally in the bark of cinnamon trees and other species of the genus Cinnamomum. Plants that make essential oils such as cinnamaldehyde reportedly synthesize the compounds in plastids, where they are released into the cytoplasm and secreted through the surrounding plasmalemma (cell membrane) and are at least locally transported into specialized cells that developed lignified and suberized (thickened) cell walls, become metabolically inactive, and compartmentalize these often toxic components from metabolically active cells (Geng et al., 2012 and references therein). Cinnamaldehyde can account for 60%-90% of the essential oils of some plant species, an amount that is toxic to surrounding metabolically active cells of the producing plant (Geng et al., 2012). Cinnamaldehyde is well known to be phytotoxic when used as an insecticide on herbaceous plants (Cloyd & Cycholl, 2002).

The high volatility and phytoxicity of cinnamaldehyde has led to recommendations for its use primarily as a disinfectant (Pscheidt and Ocamb, 2014). Because of its disinfecting properties, cinnamaldehyde has also found limited use in agricultural settings for surface contact pest control, when combined with additional preservative compounds. One plant essential oil previously used in agricultural applications and now discontinued was ProGuard® 30% Cinnamaldehyde Flowable Insecticide, Miticide and Fungicide (U.S. Pat. Nos. 6,750,256 B1 and 6,251,951 B1), containing the chemical preservative o-phenylphenol. U.S. Pat. No. 4,978,686 discloses that an antioxidant is required for use with cinnamic aldehyde for a composition which is used for application to crops. A method of protecting crops from attack of pests including insects using a composition comprising cinnamaldehyde and also requiring an antioxidant is disclosed in U.S. Pat. No. 4,978,686. Protection of crops against insect pests by applying an aqueous composition containing a cinnamaldehyde is disclosed in French patent application 2529755. U.S. Pat. No. 2,465,854 describes an insecticidal composition containing a cinnamaldehyde derivative.

In all these cases, however, cinnamaldehyde has only been effective as a contact insecticide, nematicide, miticide or fungicide, applied to the plant surface as a spray or as a soil drench, but with no established value beyond that of a disinfectant. Not contemplated or suggested were applications of cinnamaldehyde to control bacterial infections of plants, particularly to control internal bacterial infections of plants or insects, nor more particularly to control of bacteria that colonize plants or insects intracellularly, since contact with such pathogens would not likely occur, and in addition, either phytotoxicity or insect toxicity would be expected.

In some embodiments, the cinnamaldehyde of the present invention may be prepared by various synthetic methods known to those skilled in the art. For example, see, J. March, ed., Appendix B, Advanced Organic Chemistry: Reactions, Mechanisms, and Structure, 2nd Ed., McGraw-Hill, New York, 1977. Cinnamaldehyde may be prepared synthetically, for example, by oxidation of cinnamyl alcohol (Traynelis et al., J. Am. Chem. Soc. (1964) 86:298) or by condensation of styrene with formylmethylaniline (Brit. patent 504,125). Cinnamaldehyde may also be obtained by isolation from natural sources as known to those skilled in the art. Non-limiting examples of cinnamaldehyde sources include woodrotting fungus, Stereum subpileatum, or species of the genus Cinnamomum among other sources (Birkinshaw et al., 1957. Biochem. J. 66:188). In particular, cinnamon bark extract has been approved as a GRAS (Generally Recognized as Safe) material for food use based on 21 CFR (Code of Federal Regulation) part 172.515 (CFR 2009). Cinnamon bark extract contains multiple active compounds, including cinnnemaldehyde, that inhibit microorganisms (Burt 2004).

A number of the aromatic and aliphatic aldehydes may also find use in the subject invention, such as benaldehyde, acetaldehyde, piperonal, and vanillin, all of which are generally regarded as safe (GRAS) synthetic flavoring agents (21 CFR 172.515). In some embodiments, Coniferyl aldehyde may also find use in the subject invention.

Cell Penetrants

The present invention provides for plants, seeds, seedlings and plant parts such as fruit substantially free of systemic bacterial plant pathogens, particularly those plants, seeds, seedlings and plant parts previously infected with systemic bacterial pathogens of the genus Liberibacter. In some embodiments, the present invention also provides methods for controlling further systemic bacterial pathogen infections of plants using at least one aromatic aldehyde and a polar solvent and plant cell penetrant.

In some embodiments, the at least one aromatic aldehyde is combined with a cell penetrant such as benzyl alcohol.

In other embodiments, the at least one aromatic aldehyde is combined with a DMSO cell penetrant. While DMSO has been demonstrated to be effective as a cell penetrant, its phytotoxicity has always been considered to be a negative attribute, limiting its practical application in agricultural settings.

The present invention discloses the surprising finding that the phytotoxicity of aromatic aldehydes such as cinnamaldehyde, in penetrating solvents such as DMSO, if appropriately calibrated, can be used to enhance a plant's natural resistance against certain bacterial pathogens that systemically infect a plant, which is to our knowledge a previously unrecognized property of these compounds. In addition, the present invention discloses a synergistic anti-bacterial effect of aldehydes in combination with DMSO applied at discernably phytotoxic levels.

Compositions and Methods of Treating Citrus Greening

In some embodiments, the present invention teaches the use of cinnemaldehyde and solvent either alone or in combination with other active or inactive substances. In some embodiments, the compositions of the present invention may be applied by spraying, soil drenches, pouring, dipping, in the form of concentrated liquids, solutions, suspensions, powders and the like, containing such concentration of the active compound as is most suited for a particular purpose at hand. Cinnamaldehyde is highly hydrophobic and phytotoxic to plants when used at the standard rate of 4.98 ml per liter of a 30% solution normally used for contact disinfection (equal to 1.49 ml cinnamaldehyde per liter or 0.15%). Cinnamaldeyde's hydrophobic properties in particular can limit its ability to effectively function as an antibacterial agent aqueous environments (Kalemba and Kunicka 2003).

The inventors of the present invention discovered that in order to more effectively use aromatic aldehydes in foliar sprays or injectable formulations, although the aldehyde and solvent can be formulated alone, the aldehyde can be rendered more penetrating by including a surfactant such as Tween 80 or Silwet L77. In some embodiments of the present invention, other Liberibacter-curing compounds which can be used alone or in conjunction with the cinnamaldehyde include conferyl aldehyde, benaldehyde, acetaldehyde, piperonal, and vanillin, along with the terpene carvacrol.

In some embodiments, the present invention relates to a sprayable or injectable solution of Liberibacter curing compounds in greater than 5% ethyl alcohol or DMSO.

In other embodiments, the invention relates to a solution of aldehydes and any suitable polar solvent.

In some embodiments of the present invention, the composition for treating plants infected with Liberibacters comprises about 0.001%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 75%, 80%, 85%, 90%, 95%, or 100% of a Liberibacter curing compound.

In an embodiment of the present disclosure, the solution to treat plants infected with Liberibacters comprises about 0.001% to 10%, or 0.01% to 10%, or 0.1 to 10%, or 1 to 5%, or 1 to 10% of a Liberibacter curing compound.

In some embodiments the Liberibacter curing compound is an aromatic aldehyde.

In a particular embodiment the aromatic aldehyde is cinnamaldehyde:

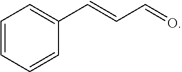

In another embodiment, the aromatic aldehyde is coniferyl aldehyde:

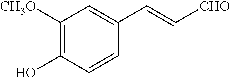

In some embodiments, Liberibacter curing compounds are selected from the group consisting of cinnamaldehyde, conferyl aldehyde, benaldehyde, acetaldehyde, piperonal, and vanillin, along with the terpene carvacrol.

In some embodiments of the present disclosure, the Liberibacter curing compound is solubilized in about 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 75%, 80%, 85%, 90%, 95%, 99% or 100% polar solvent. In some embodiments the protic solvent is ethanol, methanol, isopropanol, and acetic acid among others.

In some embodiments of the present disclosure, the Liberibacter curing compound is solubilized in about 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 75%, 80%, 85%, 90%, 95%, 99% or 100% DMSO.

In some embodiments, the formulation includes cinnamaldehyde and/or coniferyl aldehyde in a formulation involving DMSO. One formulation for treating Liberibacter infected citrus, potato or tomato, contains cinnamic aldehyde and/or coniferyl aldehyde, 0.001% to 10% by weight in 70% ethanol or 50% DMSO. In some embodiments, the total amount of aldehyde(s) present in the formulation is 1.5% or less. The formulations are effective and stable without the use of antioxidants, although particular aldehydes may have inherent antioxidant properties, for example, coniferyl aldehyde. Stability of the formulation can be evaluated by a variety of methods, including accelerated tests in which a formulation of interest is exposed to elevated temperatures over a set time. Samples of the formulations are taken at regular intervals and analyzed chemically by methods known to those skilled in the art to determine the rate and nature of degradation.

The most effective amount for compositions including cinnamaldehyde and/or coniferyl aldehyde which may find use and can be determined using protocols such as those described in the Examples. In some embodiments an effective treatment amount is about 0.01 g/l, 0.02 g/l, 0.03 g/l, 0.04 g/l, 0.05 g/l, 0.06 g/l, 0.07 g/l, 0.08 g/l, 0.09 g/l, 0.1 g/l, 0.2 g/l, 0.3 g/l, 0.4 g/l, 0.5 g/l, 0.6 g/, 0.7 g/l, 0.8 g/l, 0.9 g/l, 1 g/l, 2 g/l, 3 g/l, 4 g/l, 5 g/l, 6 g/l, 7 g/l, 8 g/l, 9 g/l, 10 g/l, 11 g/l, 12 g/l, 13 g/l, 14 g/l, 15 g/l, 16 g/l, 17 g/l, 18 g/l, 19 g/l, 20 g/l, 25 g/l, 30 g/l, 35 g/l, 40 g/l, 45 g/l, 50 g/l, 55 g/l, 60 g/l, 65 g/l, 70 g/l, 75 g/l, 80 g/l, 85 g/l, 90 g/l, 95g/l, or 100 g/l (w/v) of liberibacter curing compound. In some embodiments an effective treatment amount of liberibacter curing compound is 0.01 g/l to 25 g/l. These protocols also can be used to optimize each formulation for specific conditions as well as for use on specific plants to minimize phytotoxicity while maximizing the antipathogenic effect of the formulation.

In some instances, the efficacy of the formulation can be increased by adding one or more other components, i.e., a compound other than cinnamaldehyde to the formulation where it is desirable to alter particular aspects of the formulation. As an example, it may be desirable for certain applications to decrease the phytotoxicity or to increase the antipathogenic effect of the formulation (e. g. mean disease resistance of 60% or better, with a least about 70% or greater, see below) or both.

In some embodiments, the additional component(s) minimize phytotoxicity while increasing the antipathogenic effect of the formulation. Of particular interest is the use of a component(s) which is a synergist to increase the mean disease resistance while minimizing the phytotoxic effect as related to a particular formulation. By “synergistic” is intended a component which, by virtue of its presence, increases the desired effect by more than an additive amount.

A synergistic effect can be defined by applying the Colby formula (Colby, R. S., “Calculating Synergistic and Antagonistic Responses of Herbicide Combinations”, 1967 Weeds, vol. 15, pp. 20-22), i.e. (E)=X+Y−(X*Y/100).

The concentration of one or more of the other formulation ingredients can be modified while preserving or enhancing the desired phytotoxic and antipathogenic effect of the formulation. Of particular interest is the addition of components to a formulation to allow for a reduction in the concentration of one or more other ingredients in a given formulation while substantially maintaining efficacy of the formulation. Combination of such a component with other ingredients of the formulation can be accomplished in one or more steps at any suitable stage of mixing and/or application.

Detection of Liberibacter Infection

In some embodiments, the methods and compositions of the present invention reduce the levels of Liberibacter bacteria in infected plants. In some embodiments, the reduction is measured as a reduced bacterial titer. In other embodiments, the effectiveness of the treatments and compositions is measured by the curing of a percentage of treated plants.

In some embodiments the present invention teaches methods and compositions of curing citrus greening disease, wherein cure means the reduction of bacterial titer to the point where it is no longer detectable for an extended period of time. In some embodiments the extended period of time is 3 months, 6 months, or 9 months.

In some embodiments, the present invention teaches methods of detecting Liberibacter infections in plants.

In some embodiments, Liberibacters are detected via polymerase chain reaction (PCR) in which known sequences of the liberibacter organism are amplified and detected as a proxy for the presence of the organism itself. In some embodiments, the PCR of the present invention is quantitative PCR (qPCR) in which the presence of Liberibacters is quantified based on the number of PCR cycles required to reach a threshold quantity of gene copy product.

In other embodiments, the present invention teaches alternative methods of detecting Liberibacter infections including reverse transcriptase PCR, Northern Blots, Southern Blots, and Western Blots. In other embodiments the present invention also teaches methods of detecting Liberibacter infections via bacterial cultures of infected tissues, and immuno-labeling of infected tissues.

In other embodiments, the present invention teaches methods of detecting infected plants by the presence of citrus greening disease phenotypes described herein.

### EXAMPLE 1

### Effect of Cinnamaldehyde, Carvacrol and Geraniol on E. Coli.

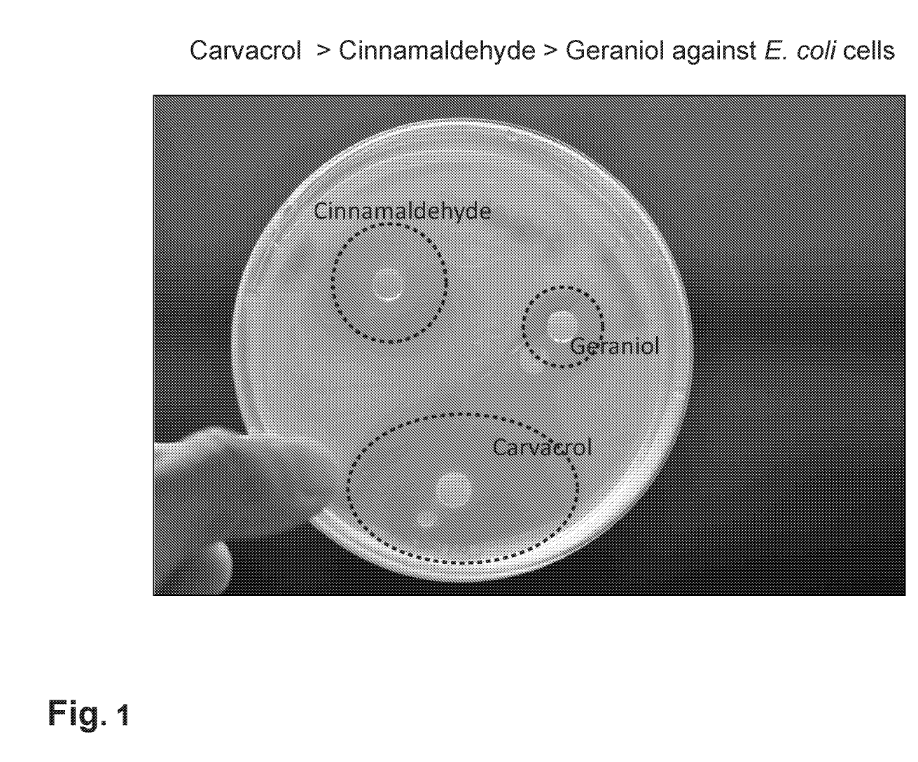

The essential oils cinnamadehyde (Aldrich, W228605; ≧98% purity), carvacrol (Aldrich, W224502; ≧98% purity) and geraniol (Aldrich, 163333; 98% purity) were purchased Sigma-Aldrich (St. Louis, Mo.). A single colony of E. coli Stratagene strain “Solopack” was inoculated in 5 ml of Luria Broth (LB) liquid medium with shaking at 37° C. overnight. Two hundred μl of the E. coli overnight cultures were placed on an LB agar plate, and spread evenly with glass beads. The bacterial culture was allowed to absorb into the LB medium. Within 30 min after absorption, 20 μl drops of the three essential oils (cinnamaldehyde, carvacrol or geraniol) were separately placed without dilution on 6 mm discs (Whatman, Cat No. 2017-006; GE healthcare Life Science) and the treated disks were placed on top of the plates with E. coli. The plates were then incubated for 24 hrs. Photos were taken at 24 hrs after plating (see FIG. 1). Experiments were repeated, with the same results.

Consistent with the literature, the results were that all three chemicals were inhibitory of the growth of E. coli, with carvacrol more inhibitory than cinnamaldehyde, which was in turn more inhibitory than geraniol.

### EXAMPLE 2

### Effect of Cinnamaldehyde, Carvacrol and Geraniol on Liberibacter Crescens.

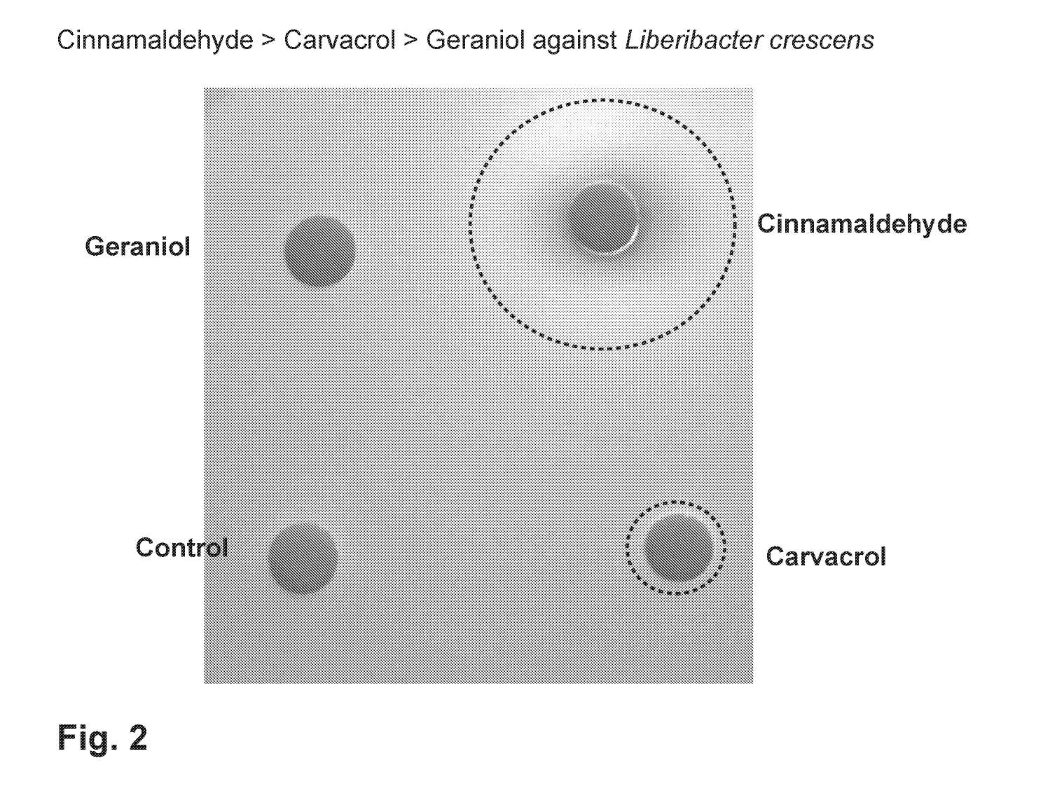

Experiments similar to those conducted in Example 1 were conducted using L. crescens strain BT-1 (Lcr), except that Lcr was cultured using BM7 medium, top agar was used, and the three chemicals (cinnamaldehyde, carvacrol and geraniol) were diluted with 70% ethanol to concentrations ranging from 2 mg/ml 0.125 mg/ml. BM7 medium contains 2 g alpha ketoguraric acid, 10 g N-(2-Acetamido)-2-aminoethanesulfonic acid, N-(Carbamoylmethyl) taurine, 3.75 g KOH, 150 ml Fetal bovine Serum, 300 ml TNM-FH in 1 Liter (L) water. Agar was added at 20 g/L for solid medium). Lcr BT-1 bacteria were incubated at 29 ° C. with shaking until reaching an optical density at 600 nm (OD600) of 0.5 -0.6. At this point, 500 μl of the cultures were added to 4 ml of 0.6% BM7 top agar, mixed well and then poured on the top of one BM7 plate and allowed to solidify. Immediately after solidifying, 20 μl drops of the three essential oils (cinnamaldehyde, carvacrol and geraniol) were placed using two-fold serial dilutions in 70% ethanol ranging from 2 mg/ml to 0.125 mg/ml on 6 mm discs and the treated disks were placed on top of the plates with Lcr. The plates were then incubated for 5 days. Photos were taken 5 days after plating. A control solution of 70% ethanol without any added essential oil was also placed on a disk and applied at the same time in each experiment. Experiments were repeated twice (see FIG. 2).

The results showed that only cinnemaldehyde and carvacrol were inhibitory of the growth of Lcr, with surprisingly strong inhibition by cinnamaldehyde at 2 mg/ml and only slight inhibition by carvacrol at the same concentration (a concentration of carvacrol, but not cinnamaldehyde, that is phytotoxic; refer Example 3 below). Geraniol was not inhibitory to Lcr at these levels. Cinnamaldehyde was also inhibitory in these tests to a level of 1 mg/ml. The Minimum Inhibitory Concentration (MIC) of cinnamaldehyde was 0.005 mg/ml.

### EXAMPLE 3

### Phytotoxic Effect of 10% Cinnamaldehyde, Carvacrol and 70% Ethanol Foliar Sprays on Citrus

To test the phytoxicity of cinnamaldehyde or carvacrol in 70% ethanol, and 70% ethanol alone on citrus plants, we applied 1% (w/v) and 10% (w/v) cinnamaldehyde or carvacrol (each dissolved in 70% ethanol) on Swingle rootstocks (˜6 inches to 1 foot tall) by spraying to the point of run-off of the spray and also sweet orange (˜3 foot tall) by painting one or both sides of a portion of the leaf surface. We also applied 70% ethanol as control in these two methods.

The results were that even 1% carvacrol in 70% ethanol was highly phytotoxic to citrus and to sweet orange leaves, observable by 24 hours after treatment. By contrast, cinnamaldehyde at 1% in 70% ethanol, and 70% ethanol alone, were not at all phytotoxic to citrus. Cinnamaldehyde at 10% w/v in 70% ethanol was moderately phytotoxic, producing chlorosis and leaf curling, but not defoliation.

### EXAMPLE 4

### Phytotoxic Effect of Cinnamaldehyde, Carvacrol and 70% Ethanol Soil Drench on Citrus

To further test the phytoxicity of cinnamaldehyde or carvacrol in 70% ethanol, and 70% ethanol alone on citrus plants, we applied 1% and 10% cinnamaldehyde or carvacrol (each dissolved in 70% ethanol) on Swingle rootstocks (˜6 inches to 1 foot tall) by adding sufficient liquid to soil of potted citrus to the point of run-off of the drench. We also applied 70% ethanol as control in these two methods.

The results were that carvacrol at 8 mg/ml (1%) of 70% ethanol was highly phytotoxic to citrus as a soil drench, observable by 60 hrs after treatment. By contrast, cinnamaldehyde at 1% in 70% ethanol, and 70% ethanol alone, were not at all phytotoxic to citrus applied as a soil drench. Cinnamaldehyde at 10% w/v in 70% ethanol was moderately phytotoxic, producing chlorosis and leaf curling, but not defoliation.

### EXAMPLE 5

### No Effect of 1% Cinnamaldehyde and 70% Ethanol Spray on Curing Las-Infected Citrus

To test the ability of 1% cinnamaldehyde to cure Las from systemically infected Pineapple Sweet Orange citrus plants grown from seeds and maintained in a greenhouse, we first graft-inoculated the plants, waited for symptoms to appear (about 6 months later) and then tested for presence of Las infection by semi-quantitative polymerase chain reaction (qPCR or PCR) tests. Granular imidacloprid was applied at recommended rates to all greenhouse grown plants. The plants were confirmed infected in multiple tests over a period of at least 3 months. We then applied 1% (w/v) cinnamaldehyde (dissolved in 70% ethanol) by spraying the foliage of infected sweet orange plants to the point of run off of the spray (˜3 foot tall trees). Subsequent qPCR tests performed 1-2 weeks later were qPCR positive and remained positive for at least several months. Positive samples were defined as those reaching a Cₜ (threshold cycle) value of less than or equal to 35, using qPCR primers and methods as described by Li et al (2006). The Cₜ value a relative measure of the concentration of target in the qPCR reaction. Control citrus plants sprayed with 70% ethanol alone were qPCR positive and remained positive for at least several months.

These results indicated that commercially available formulations of cinnamaldehyde, none of which to our knowledge were formulated with DMSO, would not by themselves kill Las or cure Las infected citrus, due to the protection afforded by their intracellular existence in plants.

### EXAMPLE 6

### Effect of 0.3% and 1.5% Cinnamaldehyde in 50% DMSO Sprayed onto HLB Symptomatic, Field Grown Citrus Moved to Pots.

To test the ability of sprayed cinnamaldehyde to cure Liberibacter from systemically infected sweet orange trees by spraying to run-off and using 50% DMSO as a penetrating solvent, approximately 3 year old mature Hamlin sweet orange trees grafted onto Swingle rootstock and exhibiting strong Huanglongbing symptoms in a field situation were pruned to approximately 4 to 5 feet in height, dug out of the field, placed in large (25 gallon) pots, brought into a greenhouse and tested for presence of Las infection by PCR. The plants were confirmed infected in multiple tests over a period of 2 weeks. These plants had been treated with imidacloprid in the field and granular imidacloprid was applied at recommended rates to all greenhouse grown plants.

We then applied 0.3% and 1.5% and cinnamaldehyde (dissolved in 50% DMSO) by spraying the foliage to the point of run off of the spray. The 1.5% cinnamaldehyde treated sweet orange trees, already stressed by uprooting and repotting, completely defoliated 6-7 days later; the 0.3% cinnamaldehyde treated plants appeared unaffected. Approximately 2 weeks later, new shoots began to emerge from the 1.5% treated plants, and the following week, new shoots were large enough to begin PCR tests for presence of Las.

The plants treated with 1.5% cinnamaldehyde in 50% DMSO were completely Las negative, but the 0.3% treated plants remained infected. Subsequent qPCR tests performed each week for the next nine months confirmed that the 1.5% treated plants were cured, with no detectable levels of Liberibacter infection and no citrus greening symptoms.

Control trees sprayed or injected with only 50% DMSO also defoliated but subsequently emerging new shoots either died or were qPCR positive. This demonstrated that DMSO alone, was not sufficient to treat Liberibacter infection.

The results from these experiments showed the surprising results that 1.5% cinnamaldehyde in 50% DMSO could be utilized to cure Las infections of citrus by spraying re-potted—and therefore highly stressed—citrus trees to run-off.

### EXAMPLE 7

### Effect of 1.5% Cinnamaldehyde and 100% DMSO Injected into HLB Symptomatic, Field Grown Citrus Moved to Pots

To test the ability of cinnamaldehyde to cure Liberibacter from systemically infected sweet orange trees when delivered using DMSO by injection, approximately 3 year old mature Hamlin sweet orange trees grafted onto Swingle rootstock and exhibiting strong Huanglongbing symptoms in a field situation were pruned to approximately 4 to 5 feet in height, dug out of the field, placed in large (25 gallon) pots, brought into a greenhouse and tested for presence of Las infection by PCR. These plants had been treated with imidacloprid in the field and granular imidacloprid was applied at recommended rates to all greenhouse grown plants. The plants were confirmed infected in multiple tests over a period of 2 weeks.

We then used two spring loaded syringes (Chemj et Tree Injectors; Queensland Plastics, Australia) on each tree. Each injector held 20 ml volume of injected material; in this case 1.5% (w/v) cinnamaldehyde in 100% DMSO. The injectors were placed in the trees by drilling a ½″ hole ca. ⅘ of the way through the diameter of each trunk, at a site approximately 12-14″ above the soil line. The injector was screwed firmly into place and the spring loaded syringe was then released, resulting in pressurized injection of the solution.

The 1.5% cinnamaldehyde injected sweet orange trees, already stressed by uprooting and repotting as in Example 6, completely defoliated 6-7 days later. Approximately 2 weeks later, new shoots began to emerge from these treated plants, and the following week, new shoots were large enough to begin PCR tests for presence of Las.

The 1.5% treated plants were completely negative, and subsequent PCR tests performed each week for the next 9 months confirmed that the 1.5% cinnamaldehyde injected plants remained completely PCR negative and were thus cured. This demonstrated that 1.5% cinnamaldehyde in 100% DMSO could be utilized to cure Las infections of citrus by injecting re-potted—and therefore highly stressed—citrus trees.

### EXAMPLE 8

### Effect of 1.5% Cinnamaldehyde and 50% DMSO on Liberibacter-Infected Citrus Trees Grown in Commercial Groves by Trunk Injection and by Spray Application

Most of the trees in an entire commercial grove of well maintained, four year old Hamlin trees grafted onto Swingle citrumello rootstock and treated regularly with imidacloprid insecticide, a plant SAR inducer (Ford et al., 2010), were found to be heavily diseased with classic symptoms of HLB, including blotchy mottling, yellowing of some branches, and premature fruit drop. Highly symptomatic citrus trees were selected, numbered and all were completely randomized as to treatment. Subsequent qPCR testing of 2-3 randomly sampled leaves per tree taken from different branches of each symptomatic tree resulted in a Las positive infection rate of greater than 70% of the trees in the grove.

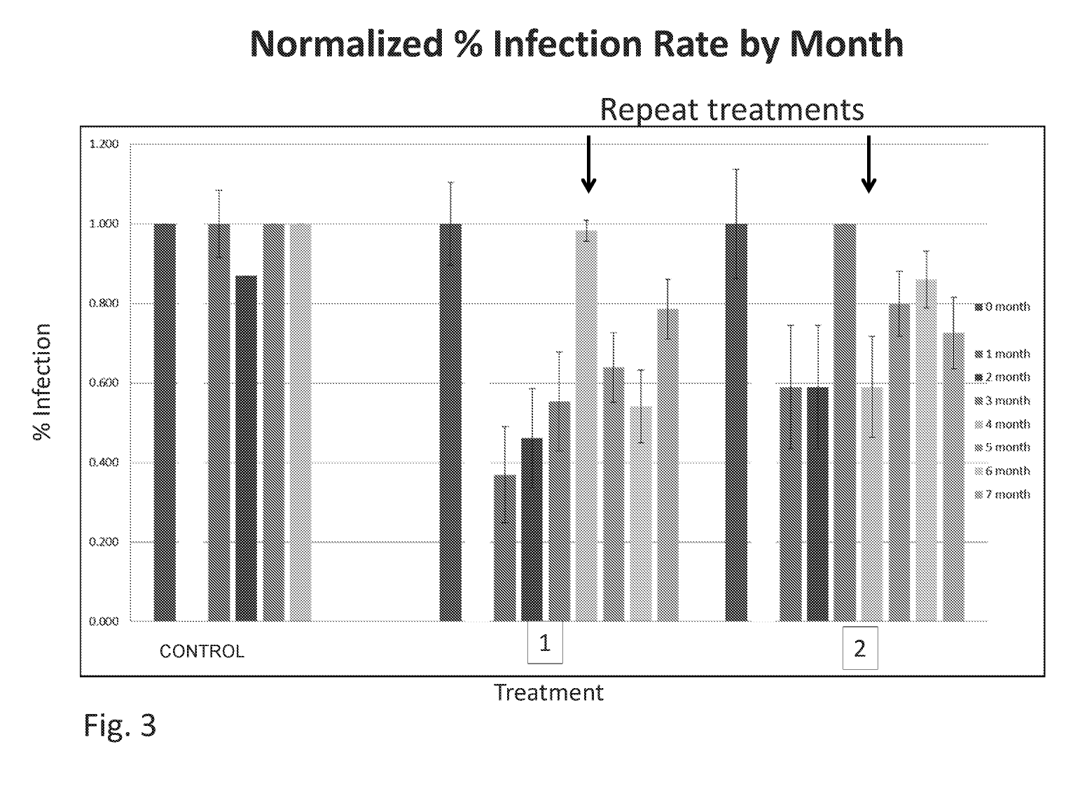

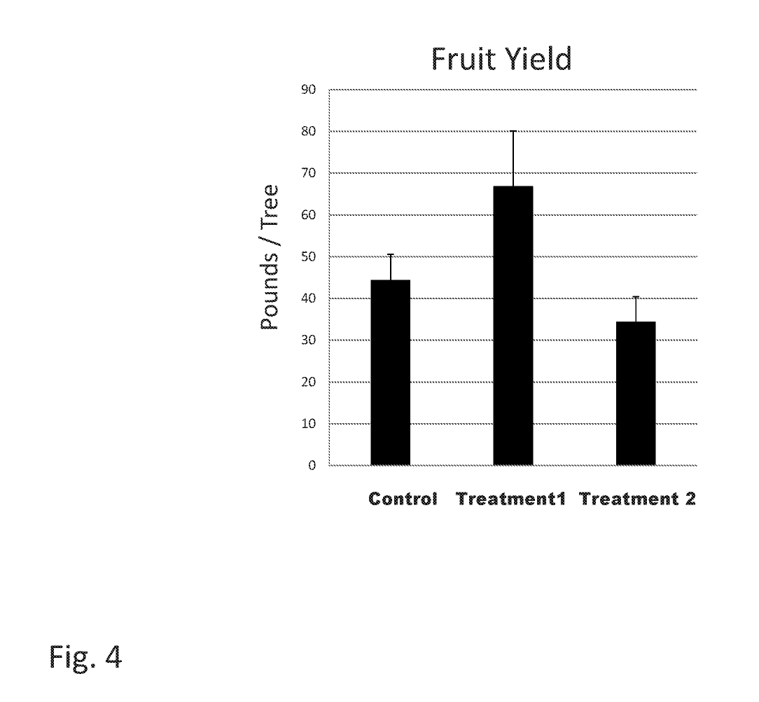

Ten symptomatic trees were randomly selected for trunk injection (Treatment 1 in FIG. 3) as outlined in Example 7, using 40 mls of 1.5% (w/v) cinnamaldehyde and 50% DMSO, and another 10 infected trees were randomly selected for spray applications using 800 ml of the same treatment in a manner similar to that used in Example 6, but using 800 ml to cover a much larger, four year old, field grown tree, such that there was no run-off (Treatment 2 in FIG. 3). Five trees each were injected and 5 trees sprayed (Controls in FIGS. 3 and 4) using 50% DMSO.

Results are presented as % Las infection (total number of positive leaf samples (assessed by qPCR as described above) divided by the total number of leaf samples taken per treatment on a given sampling date). Samples were taken monthly over a period of 6-7 months. Each bar in FIG. 3 represents average % Las infection for each treatment of 10 trees, taken month by month. The “0 month” samples are pooled averages of all trees sampled in each treatment before any treatments. Data are presented are normalized such that pre-treatment infections are 100%. Non-overlapping Standard Errors are significant at P<0.05.

From these results, it is clear that 40 ml 1.5% Cinnamaldehyde in 50% DMSO injected into large, field grown (4 year old) Hamlin citrus trees (Treatment 1 in FIG. 3) resulted in a significant reduction of Las infection (from about 100% to about 35% infection), and the result lasted for about 3 months. Spray treatments using 800 mls of 1.5% Cinnamaldehyde in 50% DMSO (Treatment 2 in FIG. 3), also had a statistically significant effect on Las infection levels, but the effect lasted only for 2 months, and appeared less effective overall at the applied application rate, based on an analysis of the total fruit yields measured from all treatments (see FIG. 4). Treatments 1 and 2 were reapplied in this field trial; both treatments were reapplied 4 months later to the same trees in the manner described. Again, similar results were observed, with infection levels becoming significantly reduced using both injection or spraying methods.

For the fruit yield data presented in FIG. 4, all trees were harvested at the same time in the fall (normal for Hamlin oranges in that field), and total fruit weight per tree measured. Treatment 1 yielded 66 pounds of fruit per tree, which was significantly higher than the yield of 45 pounds of fruit per tree from the control group (labeled “Control” in FIG. 4), while Treatment 2 yielded only 35 pounds of fruit per tree, which was not significantly different from the yield of the control group.

### EXAMPLE 9

### Effect of 1.5% Cinnamaldehyde and 5-50% DMSO on Liberibacter-Infected Potato, Tomato, Celery, and Carrot Plants

To test the ability of cinnamaldehyde to cure Liberibacter from systemically infected potato, tomato, celery, and carrot plants, including Ca. L. solanacearum and new species of Liberibacters yet to be described, the presence of Liberibacter infection will be tested by PCR using methods well known to those skilled in the art. 1.5% cinnamaldehyde (dissolved in 5-50% DMSO) will be applied to infected potato, tomato, celery and carrot plants by spraying the foliage of plants to the point of run off of the spray. Subsequent PCR tests will be performed 1-2 weeks later using PCR. It is expected that these subsequent PCR tests will be negative or will show reductions of titers after treatment.

Significantly reduced infection rates and increased produce yields are expected.

### EXAMPLE 10

### Effect of Carvacrol and 5-50% DMSO on Liberibacter-Infected Liberibacter-Infected Potato, Tomato, Celery, Citrus and Carrot Plants

To test the ability of Carvacrol to cure Liberibacter from systemically infected potato, tomato, celery, citrus, and carrot plants, including Ca. L. solanacearum and new species of Liberibacters yet to be described, the presence of Liberibacter infection will be tested by PCR using methods well known to those skilled in the art. 0.5%-10% carvacrol (dissolved in 5-50% DMSO) will be applied to infected potato, tomato, celery, citrus, and carrot plants by spraying the foliage of plants to the point of run off of the spray. Subsequent PCR tests will be performed 1-2 weeks later using PCR. It is expected that these subsequent PCR tests will be negative or will show reductions of titers after treatment.

Significantly reduced infection rates and increased produce yields are expected.

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein. All publications, patents, and patent publications cited are incorporated by reference herein in their entirety for all purposes.

The publications discussed herein are provided solely for their disclosure prior to the filing date of the present application. Nothing herein is to be construed as an admission that the present invention is not entitled to antedate such publication by virtue of prior invention.

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

### REFERENCES

Abad, J. A., Bandla, M., French-Monar, R. D., Liefting, L. W. and Clover, G. R. G. 2009. First report of the detection of ‘Candidatus Liberibacter’ species in zebra chip disease-infected potato plants in the United States. Plant Dis. 93:108.
Alfaro-Fernandez, A., Cebrian, M. C., Villaescusa, F. J., Mendoza, A. H., Ferrandiz, J. C., Sanjuan, S., and Font, M. I. 2012. First Report of ‘Candidatus Liberibacter solanacearum’ in Carrot in Mainland Spain. Plant Dis. 96:582.
Alfaro-Fernandez, A., Siverio, F., Cebrian, M. C., Villaescusa, J. F., and Font, M. I. 2012. ‘Candidatus Liberibacter solanacearum’ Associated with Bactericera trigonica-Affected Carrots in the Canary Islands. Plant Dis. 96:581-582.
Aubert B, Bové J M. 1980. Effect of penicillin or tetracycline injections of citrus trees affected by conditions in Reunion Island. Pages 103-108 In: 8th Conf. Int. Organ. Citrus Virol. B Calavan, S. M. Garnsey, L W Timmer, eds. IOCV, Riverside, Calif.
Beattie, G., Holford, P., Mabberley, D., Haigh, A., and Broadbent, P. 2008. On the origins of citrus, Huanglongbing, Diaphorina citri and Trioza erytreae. International Research Conference on Huanglongbing, Orlando, Fla., USA: 23-56.
Bosshart, P. D., Iordanov, I., Garzon-Coral, C., Demange, P., Engel, A., Milon, A., and Midler, D. J. 2012. The transmembrane protein KpOmpA anchoring the outer membrane of Klebsiella pneumoniae unfolds and refolds in response to tensile load. Structure. 20:121-127.
Bové, J. M. 2006. Huanglongbing: a destructive, newly emerging, century-old disease of citrus. J. Plant Pathol.88:7-37.
Bové, J. 2013. Heat-tolerant Asian HLB meets heat-sensitive African HLB on the Arabian Peninsula. Why? 3rd International Research Conference on HLB, Orlando, Fla., USA. (http://irchlb.org/files/74c98989-2bd2-4222-b. pdf)
Bové, J. M., and Saglio, P. 1974. Stubborn and Greening: a review, 1969-1972. Proceedings of 6^{th} Conference IOCV, IOCV, Riverside 1974, 1-11.
Burt S. 2004. Essential oils: their antibacterial properties and potential applications in foods—a review. Intl J Food Microbiol 94:223-53.
Catling, H. D. 1969. The bionomics of the South African citrus psylla, Trioza erytreae (Del Guercio) (Homoptera: Psyllidae). III. The influence of extremes of weather on survival. J. Ent. Soc. S. Africa. 32:273-290.
Cloyd, R. A. and N. L. Cycholl. 2002. Phytotoxicity of selected insecticides on greenhouse-grown herbs. HortScience 37:671-672.
de Rudder, K. E. E., Sohlenkamp, C., and Geiger, 0.1999. Plant-exudate choline is used for rhizobial membrane lipid biosynthesis by phosphatidylcholine synthase. J. Biol. Chem. 274:20011-20016.
Deng, W. L., Y. C. Lin, R. H. Lin, C. F. Wei, Y. C. Huang, H. L. Peng, and H. C. Huang. 2010. Effects of gaIU mutation on Pseudomonas syringae-plant interactions. Mol. Plant-Microbe Interact. 23:1184-1196.
Duan, Y, Zhou, L, Hall, D. G., Li, W., Doddapaneni, H., Lin, H., Liu, L., Vahling, C. M., Gabriel, D. W., Williams, K. P., Dickerman, A., Sun, Y. and Gottwald, T. 2009. Complete Genome Sequence of Citrus Huanglongbing Bacterium, “Candidatus Liberibacter asiaticus” obtained through metagenomics. Mol. Plant-Microbe Interact. 22:1011-1020.
Ford K A, Casida J E, Chandran D, Gulevich A G, Okrent R A, Durkin K A, Sarpong R, Bunnelle E M, Wildermuth M C. 2010. Neonicotinoid insecticides induce salicylate-associated plant defense responses. Proc Natl Acad Sci USA. 107:17527-32.
Friedman, M., Henika, P. R., and Mandrell, R. E. 2003. Antibacterial activities of phenolic benzaldehydes and benzoic acids against Campylobacter jejuni, Escherichia coli, Listeria monocytogenes and Salmonella enterica. J. Food Protect. 66:1811-1821
Gamier, M., Danel, N., and Bové, J. M. 1984. The greening organism is a Gram negative bacterium. Proceedings of 9th Conference IOCV, IOCV, Riverside, pages 115-124.
Geng, S. L, Cui, Z. X., Shu, B., Zhao, S. and Yu X. H. 2012. Histochemistry and cell wall specialization of oil cells related to the Essential Oil accumulation in the bark of Cinnamomum cassia Presl. (Lauraceae). Plant Prod. Sci. 15:1-9.
Geiger, O., Lopez-Lara, I. M., and Sohlenkamp, C. 2013. Phosphatidylcholine biosynthesis and function in bacteria. Biochim. Biophys ACTA-Molec. Cell Bio Lipids 1831: 503-513.
Haakanaa, K., Sarkka, L., Somersalo, S. 2001. Gaseous ethanol penetration of plant tissues positively effects the growth and commercial quality of miniature roses and dill. Sci. Horticulturae 88:71-84.
Hann, D. R., Gimenez-Ibanez, S., Rathjen, J. P. 2010. Bacterial virulence effectors and their activities. Curr. Opin. Plant Biol. 13:388-393.
Hansen, A. K., Trumble, J. T., Stouthamer, R., and Paine, T. D. 2008. A new Huanglongbing species, “Candidatus Liberibacter psyllaurous,” found to infect tomato and potato, is vectored by the psyllid Bactericera cockerelli (Sulc). Appl. Environ. Microbiol. 74:5862-5865.
Hollis, D. 1984. Afrotropical jumping plant lice of the family Triozidae (Homoptera: Psylloidea). Bull. Br. Mus. (Natl. Hist.) Entomology. 49: 1-102p.
Jagoueix, S., Bové, J. M., and Gamier, M. 1994. The phloem-limited bacterium of greening disease of citrus is a member of the a subdivision of the Proteobacteria. Int. J. Sys Bacteriol. 44:397-86.
Jeannin, P., Magistrelli, G., Goetsch, L., Haeuw, J. F., Thieblemont, N., Bonnefoy, J. Y., and Delneste, Y. 2002. Outer membrane protein A (OmpA): a new pathogen-associated molecular pattern that interacts with antigen presenting cells-impact on vaccine strategies. Vaccine. 20:A23-27.
Kawahara, K., Seydel, U., Matsuura, M., Danbara, H., Rietschel, E. T., and Zahringer, U. 1991. Chemical structure of glycosphingolipids isolated from Sphingomonas paucimobilis. FEBS Letters. 292:107-110.
Kalemba D and Kunicka A. 2003. Antibacterial and antifungal properties of essential oils. Curr Med Chem. 10:813-29.
Kawahara, K., Moll, H., Knirel, Y. A., Seydel, U., and Zahringer, U. 2000. Structural analysis of two glycosphingolipids from the lipopolysaccharide-lacking bacterium Sphingomonas capsulata. Eur. J. Biochem. 267:1837-1846.
Keck, M., Gisch, N., Moll, H., Vorholter, F.-J., Gerth, K., Kahmann, U., Lissel, M., Lindner, B., Niehaus, K., and Holst, O. 2011. Unusual outer membrane lipid composition of the Gram-negative, lipopolysaccharide-lacking Myxobacterium Sorangium cellulosum So ce56. J. Biol. Chem. 286:12850-12859.
Koebnik, R., Locher, K. P., and Van Gelder, P. 2000. Structure and function of bacterial outer membrane proteins: barrels in a nutshell. Mol. Microbiol. 37:239-253.
Laflèche, D. and Bové, J. M. 1970. Structures de type mycoplasme dans les feuilles d'orangers atteints de la maladie du greening. C.R. Acad. Sci. Paris, 270:1915-17.
Liefting, L. W., Weir, B. S., Pennycook, S. R., Clover, G. R. G. 2009. ‘Candidatus Liberibacter solanacearum’, associated with plants in the family Solanaceae. Int. J. Sys. Evol. Microbiol. 59:2274-2276.
Leonard, M. T., Fagen, J. R., Davis-Richardson, A. G., Davis, M. J., and Triplett, E. W. 2012. Complete genome sequence of Liberibacter crescens BT-1. Stand. Genomic Sci. 7:271-283.
Leone, S., Molinaro, A., Lindner, B., Romano, I., Nicolaus, B., Parrilli, M., Lanzetta, R., and Holst, O. 2006. The structures of glycolipids isolated from the highly thermophilic bacterium Thermus thermophilus Samu-SA1. Glycobiology. 16:766-775.
Li, W., Hartung, J. S., & Levy, L. 2006. Quantitative real-time PCR for detection and identification of Candidatus Liberibacter species associated with citrus huanglongbing. J. Microbiological Methods 66:104-115.
Lin, K. H. 1956a. Yellow shoot of citrus (in Chinese). Acta Phytopathologica Sinica 2: 1-12.
Lopes, S. A., Frare, G. F., Bertolini, E., Cambra, M., Fernandes, N. G., Ayres, A. J., Marin, D. R., and Bové, J. M. 2009b. Liberibacters associated with citrus huanglongbing in Brazil: ‘Candidatus Liberibacter asiaticus’ is heat tolerant, ‘Ca. L. americanus’ is heat sensitive. Plant Dis. 93:257-62.
Moran, V. C., and Blowers, J. R. 1967. On the biology of the South African citrus psylla, Trioza erytreae (Del Guercio) (Homoptera: Psyllidae). J. Ent. Soc. S. Africa 30:96-106.
Munyaneza, J. E., Sengoda, V. G., Stegmark, R., Arvidsson, A. K., Anderbrant, O., Yuvaraj, J. K., Ramert, B., and Nissinen, A. 2012a. First report of “Candidatus Liberibacter solanacearum” associated with psyllid-affected carrots in Sweden. Plant Dis. 96:453.
Munyaneza, J. E., Sengoda, V. G., Sundheim, L., and Meadow, R. 2012b. First report of “Candidatus Liberibacter solanacearum” associated with psyllid-affected carrots in Norway. Plant Dis. 96:454.
Nelson, W. R., Fisher, T. and Munyaneza, J. E. 2011. Haplotypes of “Candidatus Liberibacter solanacearum” suggest long-standing separation. Eur. J. Plant Pathology 130:5-12.
Pieterse, C M, van Wees, S C, Hoffland, E., van Pelt, J A and van Loon, L C. 1996. Systemic resistance in Arabidopsis induced by biocontrol bacteria is independent of salicylic acid accumulation and pathogenesis-related gene expression. Plant Cell 8:1225-1237.
Pscheidt, J. W., and Ocamb, C. M., senior editors. 2014. Pacific Northwest Plant Disease Management Handbook [online]. Corvallis, Oreg.: Oregon State University. http://pnwhandbooks.org/plantdisease.
Raddadi, N., Gonella, E., Camerota, C., Pizzinat, A., Tedeschi, R., Crotti, E., Mandrioli, M., Bianco, P. A., Daffonchio, D. and Alma, A. 2011. ‘Candidatus Liberibacter europaeus’ sp. nov. that is associated with and transmitted by the psyllid Cacopsylla pyri apparently behaves as an endophyte rather than a pathogen. Environ. Microbiol. 13:414-426.
Saglio, P., Laflèche, D., Bonissol, C., and Bové, J. M. 1971. Isolement, culture et observation au microscope electronique des structures de type mycoplasme associé à la maladie du stubborn des agrumes et leur comparaison avec les structures observées dans le cas de la maladie du greening des agrumes. Physiologie Végétale 9:569-582.

Schwarz, R. E., and Green, G. C. 1972. Heat requirements for symptom suppression and inactivation of the greening pathogen. Proceedings 5th Conference of the International Organization of Citrus Virologists, University of Florida Press, Gainesville, Fla., 44-51.

Schultz, C. P., V. Wolf, R. Lange, E. Mertens, J. Wecke, D. Naumann, and U. Zahringer. 1998. Evidence for a new type of outer membrane lipid in oral spirochete Treponema denticola: Functioning permeation barrier without lipopolysaccharides. J. Biol. Chem. 273:15661-15666.

Secor, G. A., Rivera, V. V., Abad, J. A., Lee, I.-M., Clover, G. R. G., Liefting, L. W., Li, X., and De Boer, S. H. 2009. Association of ‘Candidatus Liberibacter solanacearum’ with zebra chip disease of potato established by graft and psyllid transmission, electron microscopy, and PCR. Plant Dis. 93:574-583.

Smith, S. G. J., Mahon, V., Lambert, M. A., and Fagan, R. P. 2007. A molecular Swiss army knife: OmpA structure, function and expression. FEMS Microbiol. Lett. 273:1-11.

Sugawara, E., and Nikaido, H. 1992. Pore-forming activity of OmpA protein of Eschericha coli. J. Bio. Chem. 267:2507-2511.

Teixeira, D. C., Saillard, C., Eveillard, S., Danet, J. L., da Costa, P. I., Ayres, A. J. and Bové, J. 2005. “Candidatus Liberibacter americanus”, associated with citrus huanglongbing (greening disease) in Sao Paulo State, Brazil. Int. J. Sys. Evol. Microbiol. 55:1857-62.

Wessel, M., KlUsener, S., Godeke, J., Fritz, C., Hacker, S. and Narberhaus, F. 2006. Virulence of Agrobacterium tumefaciens requires phosphatidylcholine in the bacterial membrane. Mol. Microbiol. 62:906-915.

Ye, H., Shen, S., Xu, J., Lin, S., Yuan, Y. and Jones, G. S. 2013. Synertistic interactions of cinnamaldehyde in combination with carvacrol against food-borne bacteria. Food Control 34:619-623.
Zhang M Q, Duan Y P, Zhou L J, Turechek W W, Stover E, Powell Calif. 2010. Screening molecules for control of citrus huanglongbing using an optimized regeneration system for Candidatus Liberibacter asiaticus-infected periwinkle (Catharanthus roseus) cuttings. Phytopathology 100:239-245.

Zhang M Q, Powell C A, Zhou L J, He ZL, Stover E, Duan Y P. 2011. Chemical compounds effective against the citrus Huanglongbing bacterium Candidatus Liberibacter asiaticus in planta. Phytopathology 101:1097-1103.

Zipfel, C., and Robatzek, S. 2010. Pathogen-associated molecular pattern-triggered immunity: veni, vidi . . . ? Plant Physiol. 154:551-554.

1. A method for treating a plant infected with a Liberibacter, said method comprising:
a) contacting or injecting one or more parts of said plant with a composition comprising
(i) at least one aromatic aldehyde; and
(ii) at least one penetrating polar solvent;
wherein said at least one aromatic aldehyde comprises cinnamaldehyde and said at least one polar solvent comprises DMSO, and wherein the Liberibacter is selected from the group consisting of Ca. L. asiaticus, Ca. L. africanus and Ca. L. americanus, and wherein said treated plant has reduced levels of Liberibacter.

2. A method for treating a plant infected with a Liberibacter, said method comprising:
a) contacting or injecting one or more parts of said plant with a composition comprising
(i) at least one aromatic aldehyde; and
(ii) at least one penetrating polar solvent;
wherein said treated plant has reduced levels of Liberibacter.

3. The method of claim 2, wherein said at least one aromatic aldehyde comprises cinnamaldehyde.

4. The method of claim 2, wherein said at least one polar solvent comprises DMSO.

5. The method of claim 2, wherein said at least one aromatic aldehyde comprises cinnamaldehyde and said at least one polar solvent comprises DMSO.

6. The method of claim 2, wherein the composition is contacted with said plant by foliar spray.

7. The method of claim 2, wherein the composition is injected into the plant.

8. The method of claim 2, wherein the Liberibacter infection is causing citrus greening disease in said plant.

9. The method of claim 2 or 5, wherein the Liberibacter is selected from the group consisting of Ca. L. asiaticus, Ca. L. africanus and Ca. L. americanus.

10. The method of any one of claim 2, 5, or 9, wherein the method cures the plant from the Liberibacter.

11. The method of any one of claim 2, 5, 9, or 10, wherein the plant is a citrus tree or seedling.

12. A composition for reducing the levels of Liberibacter in an infected plant, said composition comprising: (a) at least one aromatic aldehyde; and (b) at least one penetrating polar solvent, wherein the at least one aromatic aldehyde comprises cinnamaldehyde and the at least one polar penetrating solvent comprises DMSO.

13. The composition of claim 12, wherein the composition is applied as a foliar spray.

14. The composition of claim 12, wherein the composition is delivered via injection into the plant.

15. The composition of claim 12, wherein the composition cures Liberibacter when applied to infected plants.

16. The composition of claim 12, wherein the Liberibacter infection causes citrus greening disease.

17. The composition of claim 12, wherein the Liberibacter is selected from the group consisting of Ca. L. asiaticus, Ca. L. africanus and Ca. L. americanus.
